(19) United States
(12) Patent Application Publication
(10) Pub. No.: US 2019/0017941 A1
(43) Pub. Date: Jan. 17, 2019

(54) OPTICAL GUIDE ASSEMBLY AND SYSTEM INCLUDING SAME

(71) Applicant: 2G Robotics Inc., Waterloo (CA)

(72) Inventors: Jason Gregory Gillham, Kitchener (CA); Christopher Allan Gilson, Markham (CA); Sajan Saeedi Gharahbolagh, Fredericton (CA); Shawn Oliver Satchell, New Hamburg (CA)

(73) Assignee: 2G Robotics Inc., Waterloo, ON (CA)

(21) Appl. No.: 16/068,256

(22) PCT Filed: Jan. 6, 2017
(86) PCT No.: PCT/CA2017/050010

§ 371 Date: Jul. 5, 2018

Related U.S. Application Data
(60) Provisional application No. 62/275,310, filed on Jan. 6, 2016.

(51) Int. Cl. G01N 21/954; G03B 17/08; G03B 17/17; G03B 37/00

(52) U.S. Cl. CPC G01N 21/954; G03B 17/08; G03B 2217/002; G03B 37/005; G03B 2215/0542; G03B 17/17

(57) ABSTRACT

An optical guide assembly for obtaining images of one or more exposed surfaces of an article that are at least partially immersed in a fluid. The optical guide assembly includes one or more sources of light, a camera, and an optical guide made of an optical medium. The light from the light source is reflected from the exposed surface to provide an initial light transmitted into the optical guide in a direction substantially orthogonal to a first surface thereof. The initial light is transmitted from the first surface through the optical medium to a second surface of the optical guide having a mirror thereon, to be reflected therefrom to provide a reflected light. The reflected light reflected from the second surface passes through a third surface of the optical guide substantially orthogonally thereto to the camera.

### CROSS-REFERENCE TO RELATED APPLICATIONS

This application claims the benefit of U.S. Provisional Patent Application No. 62/275,310, filed on Jan. 6, 2016, the entirety of which is hereby incorporated by reference.

### FIELD OF THE INVENTION

The present invention is an optical guide assembly for obtaining one or more images of one or more exposed surfaces of an article.

### BACKGROUND OF THE INVENTION

Various devices are known that are configured to obtain information about a structure (e.g., by obtaining images of the structure) that is difficult to obtain because the structure is not easily accessible, e.g., the structure may be at least partly located under water. The structure may, for example, be a pipe, or a tunnel defining a cavity therein. These devices typically include one or more light sources, and may include one or more cameras. The images obtained may be used for various purposes, e.g., for analysis of the integrity of the structure.

There are a number of problems and disadvantages associated with the prior art. For example, when the device is moved from one optical medium to another (e.g., from air to water), the accuracy of the prior art device suffers due to changes in the calibration thereof.

### SUMMARY OF THE INVENTION

There is a need for an optical guide assembly that overcomes or mitigates the defects or disadvantages of the prior art. Such defects or disadvantages are not necessarily included in those listed above.

In its broad aspect, the invention provides an optical guide assembly for obtaining one or more images of one or more exposed surfaces of an article. The exposed surface is at least partially immersed in one or more fluids. The optical guide assembly includes one or more sources of light for directing the light to the exposed surface, a camera having a focal point and positioned to face in a forward direction, and an optical guide made of an optical medium. The optical guide includes a first surface providing an interface between the fluid and the optical medium, the light being reflected from the exposed surface to provide an initial light transmitted into the optical guide in a direction substantially orthogonal to the first surface. The optical guide also includes a second surface having a mirror, the initial light being transmitted from the first surface through the optical medium to the second surface to be reflected therefrom to provide a reflected light. In addition, the optical guide also includes a third surface positioned so that the reflected light reflected from the second surface passes through the third surface substantially orthogonally thereto to the focal point of the camera, at which the reflected light provides the image(s) of the exposed surface(s).

In another aspect, the third surface is an inner spherical surface centered at the focal point of the camera. The second surface has a hyperbolic shape defining a virtual focal point thereof that is a perception point of a rearward-facing virtual camera that is defined by the mirror of the second surface. The first surface is an outer spherical surface centered on the perception point. The physical camera defines a central axis thereof on which the focal point is located, and the third surface additionally includes a third surface region with a first spherical curvature centered on the perception point of the virtual camera and aligned with the central axis. The second surface additionally includes a transparent second surface region with a second spherical curvature centered on the focal point of the camera and aligned with the central axis.

In another of its aspects, the invention provides an inspection system for providing a plurality of images of the exposed surface(s) of the article. The inspection system includes the optical guide assembly, and a drive mechanism connected with the optical guide assembly, for moving the optical guide assembly relative to the exposed surface(s).

In another of its aspects, the invention provides an optical guide for use with a camera and one or more light sources for guiding the light from the light source reflected from one or more exposed surfaces of an article. The exposed surface is at least partially immersed in a fluid. The optical guide includes an optical medium, a third surface defined by a sphere centered on a focal point of the camera, and a second surface configured for specular reflection of light therefrom and having a hyperbolic shape, the second surface defining a virtual focal point thereof at which a perception point of a rearward-facing virtual camera is located. The optical guide also includes a first surface providing an interface between the fluid and the optical medium, the first surface being at least partially defined by a sphere centered on the virtual focal point of the second surface. In addition, the optical guide includes a mounting portion for sealably securing the optical guide to a housing in which the camera is located.

In another of its aspects, the invention provides a method of obtaining a number of images of the exposed surface of the article. The method includes providing the inspection system, and transmitting the light from the light source(s) to the exposed surface(s). Also, with the drive mechanism, the optical guide assembly is moved relative to the article, so that the optical guide assembly obtains the images of the exposed surface(s).

In yet another of its aspects, the invention provides an alternative method of obtaining a number of images of the exposed surfaces of an article. The method includes providing an inspection system, and transmitting the light from the light source(s) to the exposed surfaces. Also, the article is moved relative to the optical guide assembly, so that the optical guide assembly collects the images of the exposed surface(s).

In another of its aspects, the invention provides a method of obtaining a number of rearward images of the exposed surface(s) of an article, and a number of forward images. The exposed surface is at least partially immersed in one or more fluids. The exposed surface at least partially defines a cavity in which one or more objects are positioned. The method includes providing an inspection system including an optical guide assembly configured to obtain the rearward images and the forward images, and including a drive mechanism, for moving the optical guide assembly in a forward direction relative to the exposed surfaces. Light from the light source(s) is transmitted to the exposed surface(s) and to the object(s). The optical guide assembly is moved in the forward direction relative to the article, so that the optical guide assembly simultaneously obtains the rearward images of the exposed surface(s) and the forward images, taken in the forward direction, of the object(s) in the cavity.

### BRIEF DESCRIPTION OF THE DRAWINGS

The invention will be better understood with reference to the attached drawings, in which:

FIG. 1 is a schematic view of an embodiment of a system of the invention positioned in a cavity at least partially defined by an article;

FIG. 2 is an isometric view of an embodiment of an optical guide assembly included in the system of FIG. 1, drawn at a larger scale;

FIG. 3 is a side view of the optical guide assembly of FIG. 2, drawn at a larger scale;

FIG. 4 is a longitudinal section of the optical guide assembly of FIG. 2, drawn at a smaller scale;

FIG. 5A is a longitudinal section of an alternative embodiment of the optical guide assembly of the invention;

FIG. 5B is a portion of the longitudinal section of FIG. 5A, drawn at a larger scale;

FIG. 5C is a schematic view of another embodiment of the system of the invention positioned in the cavity at least partially defined by the article; and

FIG. 6 is a schematic view illustrating a forward image and a rearward image simultaneously obtained utilizing the optical guide assembly of FIGS. 5A and 5B, drawn at a larger scale.

### DETAILED DESCRIPTION

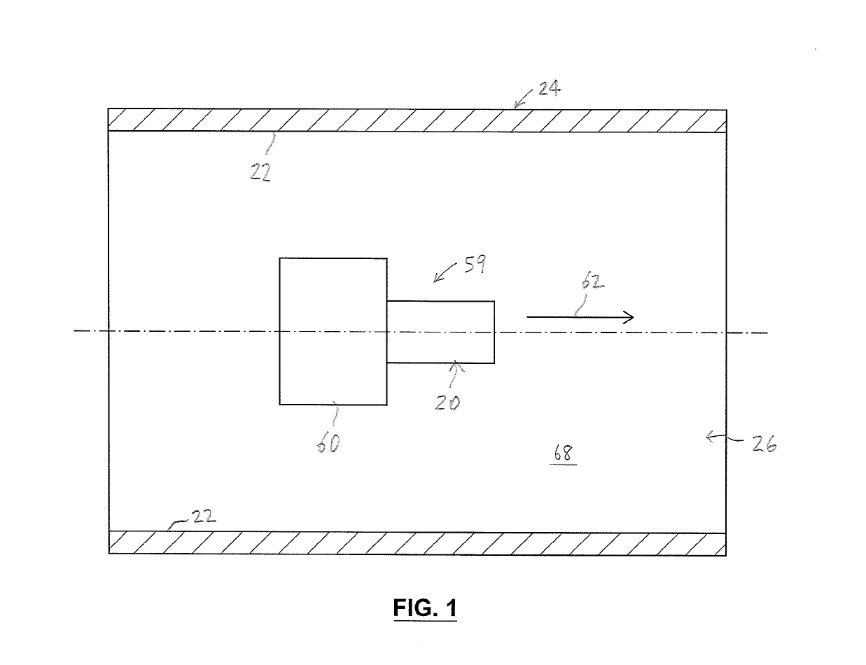

In the attached drawings, like reference numerals designate corresponding elements throughout. Reference is first made to FIGS. 1-4 to describe an embodiment of an optical guide assembly indicated generally by the numeral 20.

The optical guide assembly 20 is for obtaining one or more images of one or more exposed surfaces 22 of an article 24. As will be described, the exposed surface 22 is at least partially immersed in one or more fluids 26. In one embodiment, the optical guide assembly 20 preferably includes one or more sources 28 of light for directing the light to the exposed surface 22, a camera 30 having a focal point 32 and positioned to face in a forward direction, and an optical guide 34 that is at least partially made of an optical medium 35. In one embodiment, it is preferred that the optical guide 34 includes a first surface 36 providing an interface between the fluid 26 and the optical medium 35. The light is reflected from the exposed surface 22 to provide an initial light transmitted into the optical guide 34 in a direction substantially orthogonal to the first surface 36. The optical guide 34 preferably also includes a second surface 38 including a mirror. The initial light is transmitted from the first surface 36 through the optical medium 35 to the second surface 38 to be reflected therefrom to provide a reflected light. It is also preferred that the optical guide 34 includes a third surface 40 positioned so that the reflected light reflected from the second surface 38 passes through the third surface 40 substantially orthogonally thereto to the focal point of the camera 30, at which the reflected light provides one or more images of the exposed surface 22.

The exposed surface 22 of the article 24 may define, or partially define, a cavity 68 inside the article 24. For instance, the article 24 may be a large pipe or tube through which the optical guide assembly 20 is moved.

It will be understood that the fluid may be any liquid or gas, or any mixtures or combinations thereof. The fluid is at least partially translucent. For the purposes hereof, it will also be understood that the fluid may be a mixture of one or more fluids and solid particles or items located therein.

For example, the fluid 26 in the pipe 24 may be water, or the fluid may partially be water, and partially air. Also, there may be other items in the pipe 24, in addition to the fluid 26, e.g., debris of various types. As will be described, in one embodiment, the optical guide assembly 20 preferably is moved relative to the exposed surface 22, so that images of the exposed surface 22 along a length of the article 24 may be obtained.

Preferably, the optical guide assembly 20 includes a housing 42 in which the light source 28 and the camera 30 are mounted. It is also preferred that the housing 42 defines a camera compartment 43 in which the camera 30 is located, and the optical guide 34 is sealed to the housing 42 to provide a fluid-tight seal therewith, to prevent the fluid 26 from entering the camera compartment 43. Those skilled in the art would appreciate that the housing 42 and the optical guide 34 may be sealed to each other in various ways, to isolate the camera 30 from the fluid. Those skilled in the art would be aware of materials and structures that would be suitable for these purposes.

The camera 30 may be any suitable camera, e.g., a CCD camera. Those skilled in the art would appreciate that the images, once obtained at the camera 30, may be processed in any suitable manner. Preferably, the images are digital. The images obtained may be, for example, temporarily stored in a memory device (not shown) included in the camera or in the optical guide assembly. Alternatively, the images may be transmitted via any suitable means to an operator (not shown), who may observe the images substantially in real time.

It will be understood that the light from the light source 28 preferably illuminates a relatively large region inside the article 24, both beside and in front of the optical guide assembly 20. In particular, the light preferably illuminates a relatively large part of the exposed surface 22, i.e., preferably a part of the exposed surface that is longer than the optical guide assembly 20. Accordingly, the light from the light source 28 is reflected from the surface 22 over a broad region inside the article 24, in which the optical guide assembly 20 is located.

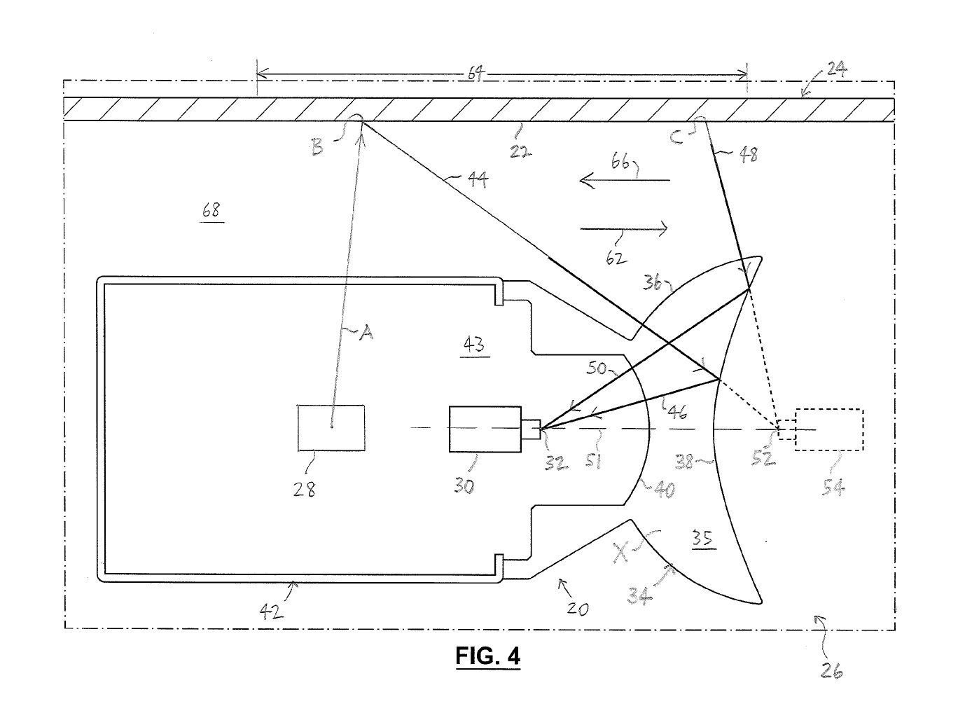

In FIG. 4, one path of the light from the light source 28 is illustrated schematically, identified for convenience as “A”. As schematically illustrated in FIG. 4, the light from the light source is directed to a point “B” on the exposed surface 22, and the light that is reflected from the exposed surface at “B” is the initial light, schematically represented by arrow 44 in FIG. 4. As described above, the initial light 44 is transmitted into the optical guide 34 in a direction that is substantially orthogonal to the first surface 36. The initial light 44 is transmitted from the first surface 44 through the optical medium 35 to the second surface 38, to be reflected therefrom to provide the reflected light. The reflected light is schematically represented by arrow 46 in FIG. 4. The reflected light 46 passes through the third surface 40 substantially orthogonally thereto to the focal point 32 of the camera 30, at which the reflected light 46 provides one or more images (not shown) of the exposed surface 22.

For clarity of illustration, only one additional set of arrows representing the light that is reflected from the exposed surface 22 of the article 24 is provided. In FIG. 4, a second arrow 48 representing a path of the initial light reflected from a second point “C” on the exposed surface 22 is also shown, to schematically illustrate a path of light reflected from the exposed surface 22 into the optical guide 34. Another arrow 50 representing a path of the reflected light resulting from the reflection of the light represented by the arrow 48 from the second surface 38 is also shown in FIG. 4.

The optical guide 34 preferably includes a body portion “X” that is made of the optical medium 35. Preferably, the optical medium 35 is a non-air medium. The optical medium 35 may be any suitable material. Preferably, the optical medium is a suitable optical grade material. Those skilled in the art would be aware of suitable optical grade material. In one embodiment, for example, the optical medium 35 is an optical grade acrylic material.

In one embodiment, the third surface 40 preferably is an inner spherical surface centered at the focal point 32 of the camera 30. The camera 30 defines a central axis 51 thereof on which the focal point 32 is located.

It is also preferred that the second surface 38 has a hyperbolic shape defining a virtual focal point thereof 52 that is a perception point of a rearward-facing virtual camera 54 that is defined by the mirror of the second surface 38. That is, the second surface 38 is a hyperbolic mirror, for specular reflection therefrom. Preferably, the first surface 36 is an outer spherical surface centered on the perception point 52.

It is believed that the light from the light source 28 that is directed into the optical guide 34 is not subject to refraction because the light is directed through the first and third surfaces 136, 140 substantially orthogonally thereto. The first surface 36 defines an interface between the optical medium 35 and the fluid 26 outside the optical guide 34. The third surface 140 defines an interface between the optical medium 35 and an internal fluid (e.g., air) that is inside the camera compartment 43.

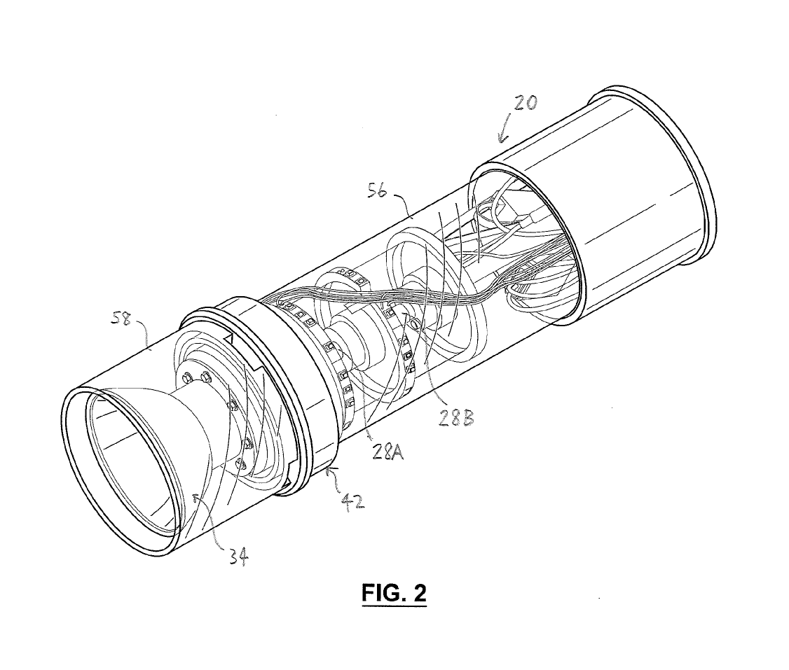

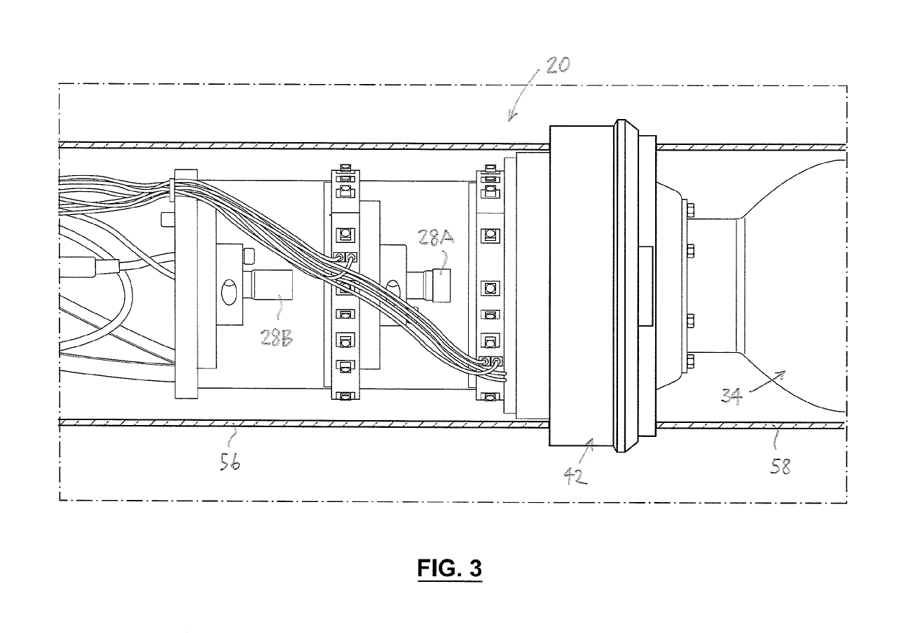

It will be understood that, although the light source 28 is shown as being located inside the housing 42, the light source may be located elsewhere. It is preferred that the light source 28 is located in the housing 42 because this simplifies positioning the light source and the camera inside a fluid-tight compartment. As can be seen in FIGS. 2 and 3, in one embodiment, the housing 42 preferably includes a transparent wall 56, to permit the light from the light source 28 to be transmitted through the wall 56 to the exposed surface 22.

In FIGS. 2 and 3, the optical guide assembly 20 illustrated therein is shown as having two light sources, designed 28A and 28B for convenience. In this embodiment, two light sources are provided to ensure that sufficient light is provided unobstructed, to obtain suitable images of the exposed surface 22.

The light source 28 preferably provides any suitable light. Preferably, the light source 28 is a source of structured light, so that the images of the exposed surface that are provided are three-dimensional images. In one embodiment, the light source is a suitable laser. Those skilled in the art would be aware of suitable light sources.

It can also be seen in FIGS. 2 and 3 that, in one embodiment, the housing 42 preferably includes a second transparent wall 58 that is positioned around the optical guide 34. The second transparent wall 58 permits the initial light that is reflected from the exposed surface 22 to be transmitted into the optical guide 34.

Those skilled in the art would appreciate that the optical guide assembly 20 preferably is moved relative to the article 24. Such movement may be achieved using various drive mechanisms that would be known to those skilled in the art. In FIG. 1, an embodiment of an inspection system 59 of the invention is schematically illustrated, the system 59 including a drive mechanism 60 for moving the optical guide assembly 20 relative to the exposed surface 22. Preferably, the optical guide assembly 20 is mounted to the drive mechanism 60. Those skilled in the art would be aware of suitable drive mechanisms 60. Preferably, the drive mechanism 60 is controllable by the operator, who is positioned remotely from the drive mechanism 60.

In use, the images of the exposed surface 22 of the article 24 preferably are obtained with the inspection system 59. In one embodiment, the method of the invention includes using the drive mechanism 60 to move the optical guide assembly 59 in a forward direction relative to the exposed surface 22 and the article 24 (FIGS. 1, 4). While the optical guide assembly 20 is moving relative to the exposed surface 22, the light from the light source 28 is transmitted outwardly from the optical guide assembly 20, and in particular, to the exposed surface 22 (FIG. 4). As described above, the light from the light source 28 reflected from the exposed surface to the optical guide 34 provides the images of the exposed surface 22 that are obtained by the camera 30.

The forward direction is indicated in FIG. 1 by arrow 62. In many situations, the article 24 is stationary, or at least temporarily stationary. For instance, the article 24 may be a pipe or tube, e.g., a large sewer pipe, and in order to obtain the images of the exposed inner surface of the pipe, the inspection system 59 is moved along the pipe in the forward direction by the drive mechanism 60. Alternatively, the article 24 may be, for instance, a shipwreck, and the exposed surface 22 may be the part of its hull that is exposed underwater, and the inspection system 59 is moved in the forward direction relative to the exposed surface of the hull. Those skilled in the art would appreciate that, in circumstances such as these, the drive mechanism 60 preferably is controlled by the operator located remotely from the drive mechanism 60.

As described above, and as can be seen in FIGS. 2-4, the first surface 36 has a generally spherical shape, i.e., it is a part of a spherical shape. The images of the exposed surface 22 that are obtained are of a portion 64 of the exposed surface 22 that is positioned at up to 360° relative to the central axis 51 of the camera 30. As can be seen in FIG. 4, the virtual camera 54 has a very wide field of view (i.e., the field of view encompasses the portion 64). In use, the ability of the inspection system 59 to obtain images of the entire exposed surface 22 is advantageous, because a complete set of images of the exposed surface 22 along a length of the article 24 can be obtained, by moving the inspection system 59 along that length of the article 24. As can be seen in FIG. 4, the images of the exposed surface 22 that are obtained are behind the optical guide 34, when the optical guide assembly 20 is moved in the forward direction. That is, the images of the exposed surface 22 that are obtained are of the portion 64 of the exposed surface 22 that is positioned rearwardly of the second surface 38 of the optical guide 34, as the inspection system 59 is moved in the forward direction. It will be understood that the inspection system 59 may alternatively be moved rearwardly relative to the exposed surface 22.

It is also possible that, in certain situations, the article 24 may be movable relative to the inspection system 59, and that it may be preferred to have the inspection system 59 remain substantially stationary while the article 24 is moved relative to the inspection system 59, In such situations, the inspection system 59 may not necessarily include the drive mechanism. As indicated in FIG. 4, for instance, the article 24 may be moved in the direction indicated by arrow 66 relative to the optical guide assembly 20. The images of the exposed surface 22 are obtained by the inspection system 59 by moving the article relative to the optical guide assembly mounted thereon, and at the same time, transmitting the light from the light source 28 to the exposed surface. In these circumstances, the optical guide assembly 20 obtains the images of the exposed surface 22 moved past the optical guide assembly 20 accordingly.

As can be seen in FIG. 4, in this situation, the images of the exposed surface 22 that are obtained are of the portion 64 of the exposed surface 22 that is positioned at up to 360° relative to the central axis.

As can be seen in FIG. 4, in this situation, the camera 30 preferably is facing in the forward direction (i.e., the direction indicated by the arrow 62), and the article 24 is moved relative to the optical guide assembly 20 in a rearward direction (indicated by the arrow 66) that is opposite to the forward direction. The portion 64 of the exposed surface 22, of which the images are obtained, is positioned rearwardly relative to the second surface 38 of the optical guide 34.

From the foregoing, it can be seen that, in one embodiment, the optical guide assembly 20 preferably includes the optical guide 34 with the body thereof made of a non-air medium and including the mirror 38. The perception point 52 of the virtual camera 54 created by the mirror 38 is in the center of a sphere defining the first (external) surface 36. The focal point 32 of the physical camera 30 is separated from the non-air medium by another spherical surface (i.e., the third surface 40) on the optical guide 34. The optical guide 34 looks backwards (i.e., rearwardly) axially, with a very wide field of view such that a complete 360° view of the portion 64 of the exposed surface 22 of the article 24 can be observed. The optical guide assembly 20 is capable of achieving this functionality with the same lens model in air or in water or in any fluids that are at least partially translucent.

Those skilled in the art would appreciate that, when the inspection system 59 is moving in the forward direction relative to the article 24, there may be one or more objects 70 in the cavity 68 inside the article 24. The objects 70 may include the fluid 26 in the article 24, which may be water or air or both water and air, and may also include solid items. In practice, the inspection system may encounter obstacles to its forward movement. As described above, the inspection system preferably is controlled remotely by the operator. Those skilled in the art would also appreciate that an ability for the operator to view in the forward direction from the inspection system would assist the operator in his efforts to direct the inspection system forwardly past the exposed surface 22.

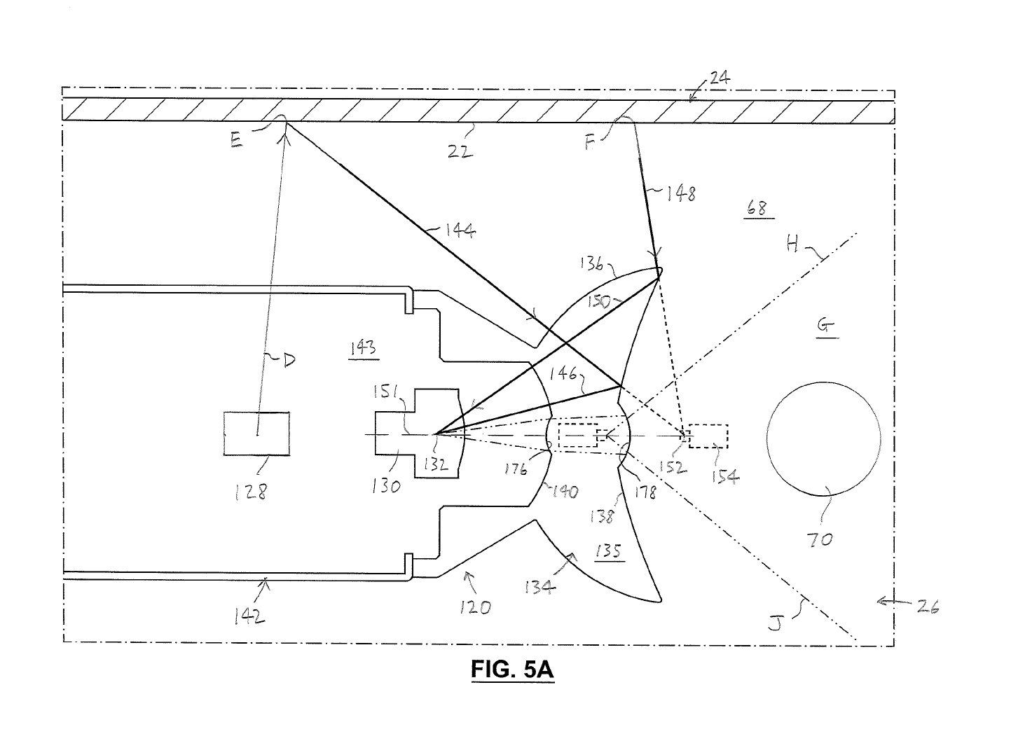

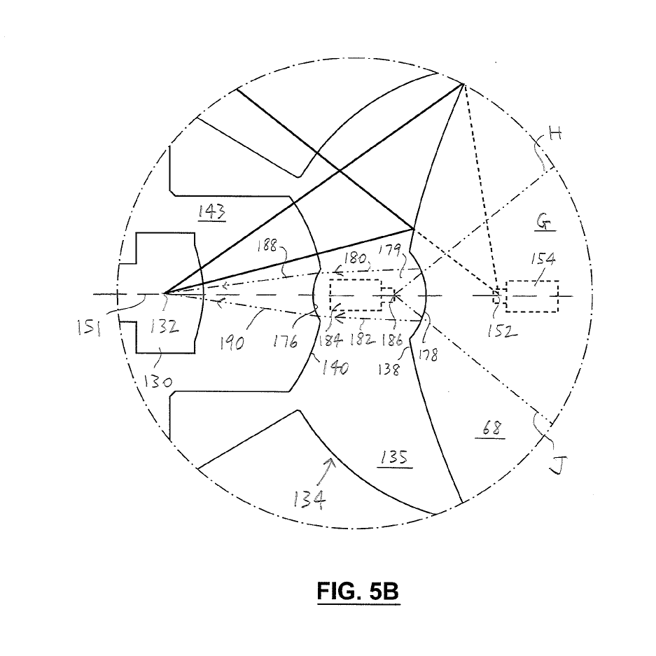

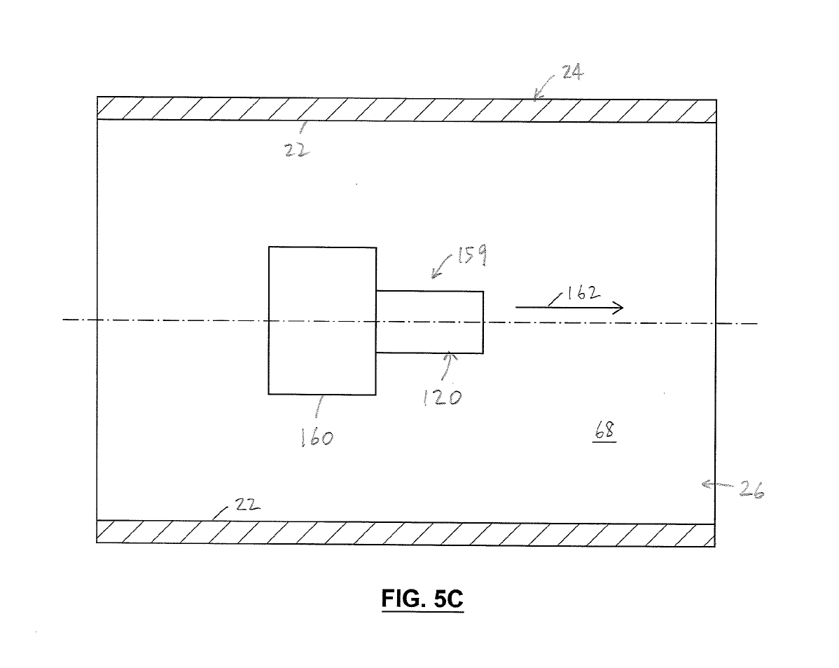

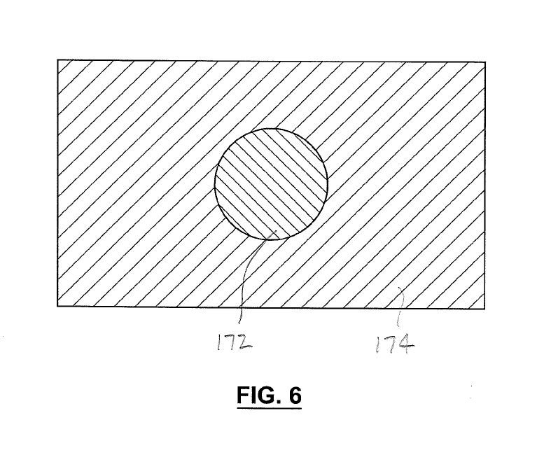

Accordingly, in one embodiment, an optical guide assembly 120 of the invention preferably provides a number of forward images 172, in addition to rearward images 174 (FIG. 6) of the exposed surface 22 described above. As can be seen in FIG. 5A, in one embodiment, the optical guide assembly 120 preferably includes a camera 130 defining a central axis 151 thereof on which a focal point 132 of the camera 130 is located. Preferably, the optical guide assembly 120 includes one or more light sources 128 and an optical guide 134 that includes first, second, and third surfaces 136, 138, 140. The second surface 138 preferably has a mirror thereon, having a hyperbolic shape defining a virtual focal point 152 thereof that is a perception point of a rearward-facing virtual camera 154 (FIG. 5A).

The optical guide 134 preferably also includes additional features that result in the forward images 172. It is preferred that the third surface 140 includes a third surface region 176 with a first spherical curvature centered on the perception point 152 of the virtual camera 154 and aligned with the central axis 151. It is also preferred that the second surface 138 additionally includes a transparent second surface region 178 with a second spherical curvature centered on the focal point 132 of the camera 130 and aligned with the central axis 151 (FIGS. 5A, 5B).

As can be seen in FIG. 5A, the optical guide assembly 120 preferably also includes a housing 142 in which the light source 128 and the camera 130 are mounted. It is also preferred that the housing 142 defines a camera compartment 143 in which the camera 130 is located. Preferably, the optical guide 134 is sealed to the housing 142 to provide a fluid-tight seal therewith, to prevent the fluid 26 from entering the camera compartment 143. Those skilled in the art would be aware of materials and structures that would be suitable for these purposes.

In FIG. 5A, one path of the light from the light source 128 is illustrated schematically, identified for convenience as “D”. As schematically illustrated in FIG. 5A, the light from the light source is directed to a point “E” on the exposed surface 22, and the light that is reflected from the exposed surface at “E” is the initial light, schematically represented by arrow 144 in FIG. 5A. As described above, the initial light 144 is transmitted into the optical guide 134 in a direction that is substantially orthogonal to the first surface 136. The initial light 144 is transmitted from the first surface 144 through the optical medium 135 to the second surface 138, to be reflected therefrom to provide the reflected light. The reflected light is schematically represented by arrow 146 in FIG. 5A. The reflected light 146 passes through the third surface 140 substantially orthogonally thereto to the focal point 132 of the camera 130, at which the reflected light 146 provides one or more rearward images 174 of the exposed surface 22.

It will be understood that the light from the light source 128 preferably illuminates a relatively large part of the exposed surface 22, i.e., preferably a part thereof that is longer than the optical guide assembly 120. The light from the light source 128 accordingly is reflected from the surface 22 over a wide area thereof. In this way, the rearward images 174 of areas of the surface 22 are provided.

For clarity of illustration, only one additional set of arrows representing the light that is reflected from the exposed surface 22 of the article 24 to provide the rearward images 174 is provided in FIG. 5A. In FIG. 5A, a second arrow 148 representing a path of the initial light reflected from a second point “F” on the exposed surface 22 is also shown, to schematically illustrate a path of light reflected from the exposed surface 22 into the optical guide 134. Another arrow 150 representing a path of the reflected light resulting from the reflection of the light represented by the arrow 148 from the second surface 138 is also shown in FIG. 5A.

Preferably, the optical medium 135 is a non-air medium. The optical medium 135 may be any suitable material. In one embodiment, for example, the optical medium 135 is any suitable optic grade acrylic material.

Except for the third surface region 176 and the second surface region 178, the optical guide 134 of FIG. 5A is generally similar to the optical guide 34 illustrated in FIG. 4. In one embodiment, except for the third surface region 176, the third surface 140 preferably is an inner spherical surface centered at the focal point 132 of the camera 130.

It is also preferred that, except for the second surface region 178, the second surface 138 has a hyperbolic shape defining a virtual focal point thereof 152 that is a perception point of a rearward-facing first virtual camera 154 that is defined by the initial light transmitted into the optical guide. Preferably, the first surface 136 of the optical guide 134 is an outer spherical surface centered on the perception point 152 (FIG. 5A).

It is believed that the light from the light source 128 that is directed into the optical guide 134 is not subject to refraction because the light is directed through the first and third surfaces 136, 140 substantially orthogonally thereto. The first surface 136 defines an interface between the optical medium 135 and the fluid 26 outside the optical guide 134. The third surface 140 defines an interface between the optical medium 135 and an internal fluid (e.g., air) that is inside the camera compartment 143.

From the foregoing, it can be seen that the rearward images 174 are of a portion of the exposed surface 22 that is positioned at up to 360° relative to the central axis 151.

It will be understood that the light from the light source 128 illuminates a forward region “G” that is forward of the optical guide 134 (FIGS. 5A, 5B), in addition to illuminating part of the exposed surface 22. Due to the second and third surface regions 178, 176, the light from the light source 128 that falls upon objects 70 within a cone of forward view providing a relatively wide angle of view (defined by lines “H” and “J” in FIGS. 5A and 5B) is reflected from the objects 70 to the focal point 132 of the camera 130, to provide the forward images 172 of the objects 70.

As can be seen in FIG. 5B, light at the outer edges of the cone of forward view is refracted upon passing through the second surface region 178, to define a region 179 in the optical medium 135, through which the light that has been reflected from the objects 70 is transmitted. The light that is thus refracted is schematically represented in FIG. 5B by arrows 180 and 182. A second, forward-facing, virtual camera 184 is defined by the cone of forward view. The second virtual camera 184 has a perception point 186 defined by the apex of the cone of forward view.

The light at the outer edges of the region 179 is further refracted upon passing through the third surface region 176. The light that is thus further refracted is schematically represented in FIG. 5B by arrows 188 and 190. As can be seen in FIG. 5B, the light represented by the arrows 188 and 190 is guided by the third surface region 176 to the focal point 132, at which the forward images 172 of the object(s) 70 are provided in the camera 130. The forward images 172 preferably are centered on the central axis 151. Accordingly, a section of pixels at the center of the physical camera 130 are mapped to the second (forward-facing) virtual camera 184.

It will be understood that, for the purposes hereof, the objects 70 may be any liquid, solid, or gases or vapors that are viewable. Those skilled in the art would appreciate that, because the operator of an inspection system 159 (FIG. 5C) that includes the optical guide assembly 120 may have the forward images 172 and the rearward images 174 provided substantially in real time, the operator may be able to cause the inspection system to move so as to avoid or minimize damage. Also, when the inspection system encounters an obstacle to its forward movement, the operator may be able to see, in the forward images, what the obstacle is, and how to deal with it. Preferably, the forward images 172 and the rearward images 174 are presented as illustrated in FIG. 6.

In one embodiment, a method of the invention of obtaining a number of the rearward images 174 of the exposed surface 22 of the article 24 and a number of the forward images 174 includes, first, providing the inspection system 159 (FIG. 5C). As noted above, the exposed surface 22 at least partially defines a cavity 68 in which the objects 70 are positioned. The exposed surface 22 is also at least partially immersed in one or more fluids 26, which may be gases and/or liquids and mixtures thereof, and may also include solids.

Preferably, the inspection system 159 includes the optical guide assembly 120, as described above. The optical guide assembly 120 preferably includes the light source 138, the camera 130, and the optical guide 134. In one embodiment, the optical guide 134 preferably includes a body 121 thereof made of the optical medium 135. The optical guide 134 preferably includes the first, second, and third surfaces 136, 138, 140, configured as described above. As is also described above, the third surface 140 preferably includes the third surface region 176 with a first spherical curvature centered on the perception point 152 of the first virtual camera 154, and aligned with the central axis 151 of the camera 130. In one embodiment, it is also preferred that the second surface 138 includes the second surface region 178, which preferably is substantially transparent. The second surface region 178 preferably has a second spherical curvature centered on the focal point 132 of the camera 130. The optical guide assembly 120 preferably also includes the housing 142, in and on which the light source 128 and the optical guide 134 are mounted.

As can be seen in FIG. 5C, the inspection system 159 preferably also includes a drive mechanism 160 for moving the optical guide assembly relative to the exposed surface 22.

Preferably, the light is transmitted from the light source into the cavity 68. It is also preferred that, while the light is transmitted into the cavity 68, the optical guide assembly 120 is moved forwardly relative to the exposed surface 22 by the drive mechanism 160. The forward direction is indicated by arrow 162 in FIG. 5C. This permits the rearward images (i.e., of the exposed surface 22) and the forward images to be obtained simultaneously, as the inspection system 159 is moved forward relative to the exposed surface 22.

It will appreciated by those skilled in the art that the invention can take many forms, and that such forms are within the scope of the invention as claimed. The scope of the claims should not be limited by the preferred embodiments set forth in the examples, but should be given the broadest interpretation consistent with the description as a whole.

We claim:

1. An optical guide assembly for obtaining at least one image of at least one exposed surface of an article, said at least one exposed surface being at least partially immersed in at least one fluid, the optical guide assembly comprising:
at least one source of light for directing the light to said at least one exposed surface;
a camera having a focal point and positioned to face in a forward direction;
an optical guide comprising an optical medium, the optical guide comprising:
a first surface providing an interface between said at least one fluid and the optical medium, the light being reflected from said at least one exposed surface to provide an initial light transmitted into the optical guide in a direction substantially orthogonal to the first surface;
a second surface comprising a mirror, the initial light being transmitted from the first surface through the optical medium to the second surface to be reflected therefrom to provide a reflected light;
a third surface positioned such that the reflected light reflected from the second surface passes through the third surface substantially orthogonally thereto to the focal point of the camera, at which the reflected light provides said at least one image of said at least one exposed surface.

2. An optical guide assembly according to claim 1 in which the optical medium is a non-air medium.

3. An optical guide assembly according to claim 1 in which said at least one light source is a source of structured light.

4. An optical guide assembly according to claim 3 in which said at least one light source is a laser.

5. An optical guide assembly according to claim 1 additionally comprising a housing in which said at least one light source and the camera are mounted.

6. An optical guide assembly according to claim 5 in which the housing defines a camera compartment in which the camera is located and the optical guide is sealed to the housing to provide a fluid-tight seal therewith, to prevent said at least one fluid from entering the camera compartment.

7. An optical guide assembly according to claim 5 in which the housing and the optical guide isolate the camera from said at least one fluid.

8. An optical guide assembly according to claim 1 in which the third surface is an inner spherical surface centered at the focal point of the camera.

9. An optical guide assembly according to claim 8 in which the second surface has a hyperbolic shape defining a virtual focal point thereof that is a perception point of a rearward-facing virtual camera that is defined by the mirror of the second surface.

10. An optical guide assembly according to claim 9 in which the first surface is an outer spherical surface centered on the perception point.

11. An optical guide assembly according to claim 10 in which:
the camera defines a central axis thereof on which the focal point is located;
the third surface additionally comprises a third surface region with a first spherical curvature centered on the perception point of the virtual camera and aligned with the central axis;
the second surface additionally comprises a transparent second surface region with a second spherical curvature centered on the focal point of the camera and aligned with the central axis.

12. An inspection system for providing a plurality of images of at least one exposed surface of an article, said at least one exposed surface being at least partially immersed in at least one fluid, the inspection system comprising:
an optical guide assembly comprising:
at least one source of light for directing the light to said at least one exposed surface;
a camera having a focal point and positioned to face in the forward direction;
an optical guide comprising an optical medium, the optical guide comprising:
a first surface providing an interface between said at least one fluid and the optical medium, the light being reflected from said at least one exposed surface to provide an initial light transmitted into the optical guide in a direction substantially orthogonal to the first surface;
a second surface comprising a mirror, the initial light being transmitted from the first surface through the optical medium to the second surface to be reflected therefrom to provide a reflected light;
a third surface positioned such that the reflected light reflected from the second surface passes through the third surface substantially orthogonally thereto to the focal point of the camera, at which the reflected light provides the images of said at least one exposed surface; and
a housing in which said at least one light source and the camera are mounted; and
a drive mechanism connected with the optical guide assembly, for moving the optical guide assembly relative to said at least one exposed surface.

13. An optical guide for use with a camera and at least one light source for guiding the light from said at least one light source reflected from at least one exposed surface of an article, said at least one exposed surface being at least partially immersed in at least one fluid, the optical guide comprising:
an optical medium;
a third surface defined by a sphere centered on a focal point of the camera;
a second surface configured for specular reflection of light therefrom and having a hyperbolic shape, the second surface defining a virtual focal point thereof at which a perception point of a rearward-facing virtual camera is located;
a first surface providing an interface between said at least one fluid and the optical medium, the first surface being at least partially defined by a sphere centered on the virtual focal point of the second surface; and
a mounting portion for sealably securing the optical guide to a housing in which the camera is located.

14. A method of obtaining a plurality of images of at least one exposed surface of an article, said at least one exposed surface being at least partially immersed in at least one fluid, the method comprising:
(a) providing an inspection system comprising:
an optical guide assembly comprising:
at least one source of light, for directing the light toward said at least one exposed surface;
a camera having a focal point and positioned to face in the forward direction, the camera defining a central axis on which the focal point is located;
an optical guide comprising an optical medium, the optical guide comprising:
a first surface providing an interface between said at least one fluid and the optical medium, the light being reflected from said at least one exposed surface to provide an initial light transmitted into the optical guide in a direction substantially orthogonal to the first surface;
a second surface comprising a mirror, the initial light being transmitted from the first surface through the optical medium to the second surface to be reflected therefrom to provide a reflected return light;
a third surface positioned such that the reflected light reflected from the second surface passes through the third surface substantially orthogonally thereto to the focal point of the camera, at which the reflected return light provides the images of said at least one exposed surface;
a housing in which said at least one light source and the camera are mounted;
a drive mechanism, for moving the optical guide assembly in a forward direction relative to said at least one exposed surface;
(b) transmitting the light from said at least one light source to said at least one exposed surface; and
(c) with the drive mechanism, moving the optical guide assembly relative to the article, wherein the optical guide assembly obtains the images of said at least one exposed surface.

15. A method according to claim 14 in which the images of said at least one exposed surface that are obtained are of a portion of said at least one exposed surface that is positioned at up to 360° relative to the central axis.

16. A method according to claim 14 in which the images of said at least one exposed surface that are obtained are of a portion of said at least one exposed surface that is positioned rearwardly of the second surface.

17. A method of obtaining a plurality of images of at least one exposed surface of an article, said at least one exposed surface being at least partially immersed in at least one fluid, the method comprising:
(a) providing an inspection system comprising:
an optical guide assembly comprising:
at least one source of light, for directing the light toward said at least one exposed surface;
a camera having a focal point and positioned to face in a forward direction, the camera defining a central axis on which the focal point is located;
an optical guide comprising an optical medium, the optical guide comprising:
a first surface providing an interface between said at least one fluid and the optical medium, the light being reflected from said at least one exposed surface to provide an initial light transmitted into the optical guide in a direction substantially orthogonal to the first surface;
a second surface comprising a mirror, the initial light being transmitted from the first surface through the optical medium to the second surface to be reflected therefrom to provide a reflected light;
a third surface positioned such that the reflected light reflected from the second surface passes through the third surface substantially orthogonally thereto to the focal point of the camera, at which the reflected light provides the images of said at least one exposed surface;
a housing in which said at least one light source and the camera are mounted;
(b) transmitting the light from said at least one light source to said at least one exposed surface; and
(c) moving the article relative to the optical guide assembly, wherein the optical guide assembly collects the images of said at least one exposed surface.

18. A method according to claim 17 in which the images of said at least one exposed surface that are obtained are of a portion of said at least one exposed surface that is positioned at up to 360° relative to the central axis.

19. A method according to claim 17 in which:
the article is moved relative to the optical guide assembly in a rearward direction opposite to the forward direction, and a portion of said at least one exposed surface, of which the images are obtained, is positioned rearwardly relative to the second surface.

20. A method of obtaining a plurality of rearward images of at least one exposed surface of an article and a plurality of forward images, said at least one exposed surface being at least partially immersed in at least one fluid, said at least one exposed surface at least partially defining a cavity in which at least one object is positioned, the method comprising:
(a) providing an inspection system comprising:
an optical guide assembly comprising:
at least one source of light for directing the light to said at least one exposed surface, and to said at least one object;
a camera defining a central axis thereof on which a focal point thereof is located, the camera being positioned to face in the forward direction;
an optical guide comprising an optical medium, the optical guide comprising:
a first surface providing an interface between said at least one fluid and the optical medium, the light being reflected from said at least one exposed surface to provide an initial light transmitted into the optical guide in a direction substantially orthogonal to the first surface;
a second surface comprising a mirror, the initial light being transmitted from the first surface through the optical medium to the second surface to be reflected therefrom to provide a reflected return light, the second surface having a hyperbolic shape defining a virtual focal point thereof that is a perception point of a rearward-facing virtual camera that is defined by the mirror of the second surface;
a third surface positioned such that the reflected light reflected from the second surface passes through the third surface substantially orthogonally thereto to the focal point of the camera, at which the reflected return light provides the rearward images of said at least one exposed surface;
the third surface additionally comprising a third surface region with a first spherical curvature centered on the perception point of the virtual camera and aligned with the central axis;
the second surface additionally comprising a transparent second surface region with a second spherical curvature centered on the focal point of the camera and aligned with the central axis, a second portion of the light from said at least one light source being reflected from said at least one object through the first and second surface regions to the focal point, to provide the forward images of said at least one object in the cavity;
a housing in which said at least one light source and the camera are mounted;
a drive mechanism, for moving the optical guide assembly in a forward direction relative to said at least one exposed surface;
(b) transmitting the light from said at least one light source to said at least one exposed surface and to said at least one object; and
(c) moving the optical guide assembly in the forward direction relative to the article, wherein the optical guide assembly simultaneously obtains the rearward images of said at least one exposed surface and the forward images taken in the forward direction of said at least one object in the cavity.

21. A method according to claim 20 in which the rearward images of said at least one exposed surface that are obtained are of a portion of said at least one exposed surface that is positioned at up to 360° relative to the central axis.

22. A method according to claim 20 in which the forward images are centered on the central axis.
